(19) United States
(12) Patent Application Publication
(10) Pub. No.: US 2005/0163021 A1
(43) Pub. Date: Jul. 28, 2005

(54) Recording medium using ferroelectric substance, recording apparatus and reproducing apparatus

(75) Inventors: Osamu Kumasaka, Saitama (JP); Takanobu Higuchi, Saitama (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/038,497

(22) Filed: Jan. 21, 2005

(30) Foreign Application Priority Data
Jan. 23, 2004 (JP) 2004-015891

(51) Int. Cl. G11B 9/00

(52) U.S. Cl. 369/126

(57) ABSTRACT

A recording medium (10) is formed by laminating a conductive layer (11), a ferroelectric layer (12), a control layer (13), and a conductive layer (14), in order. Moreover, the control layer (13) is formed from a material that has an insulation property in a normal state but becomes conductive by irradiation of an energy beam. Then, the insulation property and conductivity of the control layer (13) is changed by presence or absence, or strength or weakness of the irradiation of the energy beam (B). When the control layer (13) exhibits the conductivity, a voltage supplied between the conductive layers (11, 14) is applied to the ferroelectric layer (12). When the control layer (13) exhibits the insulation property, the application of the voltage is cut off. The application and cut-off of the voltage to the ferroelectric layer (12) realize recording of information into the ferroelectric layer (12).

### BACKGROUND OF THE INVENTION

1. Field of the Invention

The present invention relates to a recording medium in which information is held by using spontaneous polarization of a ferroelectric substance, a recording apparatus for recording information into the recording medium, and a reproducing apparatus for reproducing information held in the recording medium.

2. Description of the Related Art

As high-density information recording media, there are known a magnetic memory, an optical memory, and the like. As the magnetic memory, for example, a hard disk drive is widespread. As the optical memory, a Compact Disc (CD), a DVD, and the like are widespread. In the field of such high-density information recording media, research and development is carried out every day to improve the recording density of the recording media. These recording media, however, have limits in the improvement of the recording density, because of superparamagnetic limit in the magnetic memory, and because of diffraction limit in the optical memory. In the magnetic memory, for example, the limit of the recording density is known to be 1 terabit per 6.45 square centimeter (1 square inch), even by using perpendicular recording.

On the other hand, there is known a ferroelectric recording medium in which information is held by using spontaneous polarization of a ferroelectric substance. The ferroelectric recording medium is still developing, and is not generally spread. In the ferroelectric recording medium, theoretically, it is possible to improve the recording density thereof to the density of a crystalline lattice unit of the ferroelectric substance. Therefore, according to the ferroelectric recording medium, it is possible to exceed the limit of the recording density in the magnetic memory and the optical memory. For example, according to a recording/reproducing method to which a technique of Scanning Nonlinear Dielectric Microscope (SNDM) is applied (hereinafter, referred to as a SNDM method), it is clearly shown by experiments that it is possible to record information into the ferroelectric substance at a recording density of 1.5 terabit per 6.45 square centimeter, and reproduce the information.

Japanese Patent Application Laying Open NO. 2003-085969 describes a technique of recording and reproducing information with respect to a ferroelectric recording medium by using the SNDM method. The record and reproduction of the information in the SNDM method will be outlined below.

For the record and reproduction of the information, a nano-scaled probe formed from metal, such as tungsten, is used. In recording the information into the ferroelectric recording medium, the probe is contacted with a surface (i.e. a recording surface) of the ferroelectric recording medium, or the probe is brought extremely close to the surface of the ferroelectric recording medium. Then, an electric field beyond a coercive electric field of the ferroelectric recording medium is applied from the probe to the ferroelectric recording medium, to thereby reverse a polarization direction of the ferroelectric recording medium located under the probe. This application voltage is used as a pulse signal whose level changes in accordance with the information to be recorded, and while the pulse signal is applied to the ferroelectric recording medium via the probe, the position of the probe with respect to the ferroelectric recording medium is displaced parallel to the surface of the ferroelectric recording medium. By this, it is possible to record the information as a polarization state of the ferroelectric recording medium.

On the other hand, in reproducing the information recorded in the ferroelectric recording medium, it is used that a non-linear dielectric constant varies depending on the polarization direction of the ferroelectric substance. Namely, the non-linear dielectric constant of the ferroelectric recording medium is read by detecting a change in capacitance of the ferroelectric recording medium, to thereby reproduce the information recorded as the polarization state of the ferroelectric recording medium. Specifically, the probe is contacted with the surface of the ferroelectric recording medium, or the probe is brought extremely close to the surface of the ferroelectric recording medium. Then, an alternating electric field smaller than the coercive electric field is applied to the ferroelectric recording medium, to thereby make such a condition that the capacitance of the ferroelectric recording medium changes alternately. In this condition, the capacitance change of the ferroelectric recording medium is detected via the probe, to reproduce the information.

Japanese Patent Publication NO. 2869651 describes an optical memory in which information is held by using spontaneous polarization of a ferroelectric substance. This optical memory realizes the recording of the information by using the fact that a coericive electric field of a ferroelectric thin film lowers as the temperature of the ferroelectric thin film increases. Specifically, while an application electric field lower than the coercive electric field of the ferroelectric thin film is applied to the ferroelectric thin film, the ferroelectric thin film is irradiated with a light beam. The irradiation of the light beam heats the ferroelectric thin film. When the coercive electric field becomes lower than the application voltage, the polarization direction of the ferroelectric thin film is reversed, in accordance with the application voltage. This reverse of the polarization direction causes the information to be recorded.

In the ferroelectric recording, in which the SNDM method described in Japanese Patent Application Laying Open NO. 2003-085969 is used, the probe, which is formed from metal, is contacted with or brought close to the surface of the ferroelectric recording medium, to thereby record or reproduce the information. Thus, in recording and reproducing the information by contacting the probe with the surface of the ferroelectric recording medium, the tip of the probe or the surface of the ferroelectric recording medium is worn away because of friction between the probe and the surface of the ferroelectric recording medium, which possibly shortens the lifetime of the probe or the ferroelectric recording medium. Moreover, because of the friction between the probe and the surface of the ferroelectric recording medium, it is difficult to perform high-speed displacement (or scan) of the probe during the record or reproduction. Also, if the information is recorded or reproduced by bringing the probe close to the surface of the ferroelectric recording medium, there is a possibility that the probe is contacted with the surface of the ferroelectric recording medium by mistake, to thereby damage the probe or the ferroelectric recording medium.

Moreover, in the ferroelectric recording medium in which the information is held by using the spontaneous polarization of the ferroelectric substance, it is conceivable that the entire information recorded in the ferroelectric recording medium is deleted and the ferroelectric recording medium is initialized, by arranging the polarization directions of the ferroelectric recording medium in a uniform direction throughout the surface (i.e. the recording surface) of the ferroelectric recording medium. In order to realize this, an electric field beyond the coercive electric field may be applied to the ferroelectric recording medium as a whole. However, in the ferroelectric recording medium, which uses the SNDM method described in Japanese Patent Application Laying Open NO. 2003-085969, an electric field beyond the coercive electric field is applied to the ferroelectric recording medium via the probe, so that the entire surface of the ferroelectric recording medium is to be scanned by the probe in order to apply the electric field to the ferroelectric recording medium as a whole. Thus, it takes time to initialize the ferroelectric recording medium.

On the other hand, in the optical memory described in Japanese Patent Publication NO. 2869651, the information is recorded by using the fact that a coercive electric field of a ferroelectric thin film lowers as the temperature of the ferroelectric thin film increases. Thus, for example, it is necessary to consider a Curie point of the ferroelectric thin film, and it is not always easy to select a suitable ferroelectric material to be used.

### SUMMARY OF THE INVENTION

It is therefore a first object of the present invention to provide a recording medium of a completely non-contact type in which information is held by using spontaneous polarization of a ferroelectric substance.

It is a second object of the present invention to provide a recording medium in which information is held by using spontaneous polarization of a ferroelectric substance and which is excellent in durability and which is long-lived.

It is a third object of the present invention to provide a recording medium in which information is held by using spontaneous polarization of a ferroelectric substance and it is possible to speed up a scan for recording or reading the information.

It is a fourth object of the present invention to provide a recording medium in which information is held by using spontaneous polarization of a ferroelectric substance and the recording medium can be initialized easily and in a short time.

It is a fifth object of the present invention to provide a recording apparatus and a reproducing apparatus, which can record and reproduce information, in a completely non-contact condition, with respect to a recording medium in which information is held by using spontaneous polarization of a ferroelectric substance.

It is a sixth object of the present invention to provide a recording apparatus and a reproducing apparatus, which can record and reproduce information with respect to a recording medium in which information is held by using spontaneous polarization of a ferroelectric substance, and which is excellent in durability and which is long-lived.

It is a seventh object of the present invention to provide a recording apparatus and a reproducing apparatus, on which it is possible to speed up a scan for recording or reading information with respect to a recording medium in which the information is held by using spontaneous polarization of a ferroelectric substance.

The above objects of the present invention can be achieved by a recording medium for holding information by spontaneous polarization of a ferroelectric substance. The recording medium is provided with: a first conductive layer; a ferroelectric layer which is formed on the first conductive layer and which holds the information by spontaneous polarization; a control layer which is formed on the ferroelectric layer and in which conductivity thereof is reversibly increased by irradiation of an energy beam; and a second conductive layer formed on the control layer.

The above objects of the present invention can be also achieved by a recording apparatus for recording information into a recording medium provided with: a first conductive layer; a ferroelectric layer which is formed on the first conductive layer and which holds the information by spontaneous polarization; a control layer which is formed on the ferroelectric layer and in which conductivity thereof is reversibly increased by irradiation of an energy beam; and a second conductive layer formed on the control layer. The recording apparatus is provided with: a voltage supplying device for supplying a voltage for setting a polarization direction of the ferroelectric layer between the first conductive layer and the second conductive layer; a beam irradiating device for irradiating the recording medium with the energy beam; and an irradiation position controlling device for displacing an irradiation position of the energy beam with respect to the recording medium, in a direction parallel to a surface of the recording medium.

The above objects of the present invention can be also achieved by a reproducing apparatus for reproducing information held in a recording medium provided with: a first conductive layer; a ferroelectric layer which is formed on the first conductive layer and which holds the information by spontaneous polarization; a control layer which is formed on the ferroelectric layer and in which conductivity thereof is reversibly increased by irradiation of an energy beam; and a second conductive layer formed on the control layer. The reproducing apparatus is provided with: a voltage supplying device for supplying a voltage between the first conductive layer and the second conductive layer; a beam irradiating device for irradiating the recording medium with the energy beam; a detecting device for detecting a polarization direction of the ferroelectric layer; and an irradiation position controlling device for displacing an irradiation position of the energy beam with respect to the recording medium, in a direction parallel to a surface of the recording medium.

The nature, utility, and further features of this invention will be more clearly apparent from the following detailed description with reference to preferred embodiment of the invention when read in conjunction with the accompanying drawings briefly described below.

### BRIEF DESCRIPTION OF THE DRAWINGS

FIG. 1 is a cross sectional view showing a recording medium in a first embodiment of the present invention;

FIG. 2 is a cross sectional view showing the magnified recording medium in FIG. 1;

FIG. 3 is a cross sectional view showing a recording medium in a second embodiment of the present invention;

FIG. 4 is a block diagram showing a recording apparatus in an embodiment of the present invention;

FIG. 5 is a block diagrams showing a recording apparatus in a modified embodiment of the present invention;

FIG. 6 is a block diagrams showing a recording apparatus in another modified embodiment of the present invention;

FIG. 7 is a block diagram showing a reproducing apparatus in an embodiment of the present invention; and

FIG. 8 is a block diagram showing a recording/reproducing apparatus in an example of the present invention.

### DETAILED DESCRIPTION OF THE PREFERRED EMBODIMENTS

Embodiments of the present invention will be explained with reference to the drawings. Incidentally, the content of the drawings used in the embodiments of the present invention embodies constituent elements of the present invention or the like, as long as it explains the technological idea of the present invention. The shapes, sizes, positions, and connection relationships of the constitutional elements or the like are not limited to the embodiments. A more specific example to implement the present invention will be disclosed in a section of “Example”.

### First Embodiment of Recording Medium

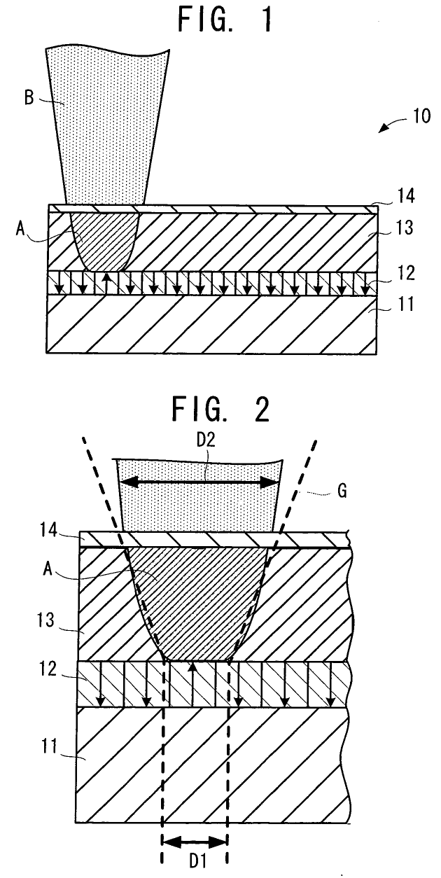

The first embodiment of the recording medium of the present invention will be explained. FIG. 1 shows a recording medium in the first embodiment of the present invention and an energy beam emitted to the recording medium. FIG. 2 shows the magnified recording medium in FIG. 1. The recording medium 10 in FIG. 1 is a recording medium in which information is held by spontaneous polarization of a ferroelectric substance. As in the magnetic memory, such as a hard disc drive, and the optical memory, such as an optical disc, the recording medium 10 is an information recording medium in which the information is recorded and held, and in which reading and reproduction of the recorded information is realized. However, the recording medium 10 uses a ferroelectric substance as a material for a recording layer, and the information is recorded and held as the polarization direction of the ferroelectric substance. Thus, theoretically, it is possible to improve the recording density to the density of the crystalline lattice unit of the ferroelectric substance. Therefore, in the recording medium 10, it is possible to realize a higher recording density than those of the conventional magnetic memory and optical memory.

As shown in FIG. 1, the recording medium 10 is provided with: a first conductive layer 11; a ferroelectric layer 12; a control layer 13; and a second conductive layer 14.

The conductive layer 11 functions as an electrode for applying a voltage to the ferroelectric layer 12, along with the conductive layer 14. The conductive layer 11 is formed from a conductive material. For example, the conductive layer 11 is formed from metal, such as aluminum, platinum, gold, copper, and nickel. The conductive layer 11 is formed in a plate shape or in a thin-film shape. The thickness of the conductive layer 11 is not particularly limited, but it is desirably several tens nanometers or more. Incidentally, the conductive layer 11 may function as not only an electrode but also as a substrate of the recording medium 10. In this case, in order to increase the strength of the recording medium 10, the conductive layer 11 is thickened.

The ferroelectric layer 12 has a function of holding the information by spontaneous polarization of a ferroelectric substance. The ferroelectric layer 12 is formed on the conductive layer 11. The ferroelectric layer 12 is formed from a ferroelectric material. As the ferroelectric material, lead titanate (PbTiO₃), lead zirconate (PbZrO₃), barium titanate (BaTiO₃), lithium niobate (LiNbO₃), lithium tantalite (LiTaO₃), and the like can be used. For example, LiTaO₃ with a crystal face of Z-cut is appropriate as the ferroelectric material in which the information is recorded as the polarization direction that is perpendicular to the surface of the recording medium 10. The ferroelectric layer 12 is formed in a thin-film shape. The thickness of the ferroelectric layer 12 is desirably several tens nanometers or several hundreds nanometers.

The principle in which the information is recorded and held in the ferroelectric layer 12 is as follows. Namely, a ferroelectric substance has such a property that the polarization direction changes by applying an electric field beyond the coercive electric field of the ferroelectric substance. Moreover, the ferroelectric substance has such a property that if the polarization direction is changed by the application of an electric field, even if the application of the electric field is stopped afterward, the ferroelectric substance maintains the polarization direction (i.e. the spontaneous polarization). By using these properties, the information is recorded and held in the ferroelectric layer 12. For example, the polarization directions of the entire ferroelectric layer 12 are arranged in advance in one direction perpendicular to the surface of the recording medium 10 (e.g. downward as shown in FIG. 1). Then, the electric field beyond the coercive electric field is locally applied to the ferroelectric layer 12, in the direction perpendicular to the surface of the recording medium 10. By this, the polarization direction is reversed in a portion where the electric field is applied, and even if the application is stopped afterward, the reversed state of the polarization direction is maintained. For example, in FIG. 1, if the information to be recorded is binary digital data of “0” and “1”, the bit state “0” is related to the downward polarization direction, and the bit state “1” is related to the upward polarization direction. In this case, the electric field may be applied only when the bit state “1” is recorded. In this manner, the information can be recorded and held in the ferroelectric layer 12.

On the other hand, the principle in which the information recorded in the ferroelectric layer 12 as the polarization direction is reproduced is as follows. Namely, the non-linear dielectric constant of a ferroelectric substance varies depending on the polarization direction. It is possible to know the difference in the non-linear dielectric constant by applying an alternating electric field smaller than the coercive electric field, in the direction perpendicular to the surface of the recording medium 10, and by detecting a change in the capacitance of the ferroelectric substance. The capacitance change of the ferroelectric substance is small at this time, but according to the SNDM method, it is possible to detect the capacitance change. In this manner, it is possible to read the polarization direction of the ferroelectric layer 12 by detecting the non-linear dielectric constant (i.e. the capacitance change), to thereby reproduce the information.

The control layer 13 has such a property that its conductivity is reversibly increased by irradiation of an energy beam B. The control layer 13 has such a property that it changes the conductivity by presence or absence, or strength or weakness, of the energy beam B. By using this property, the control layer 13 selects whether or not to apply a voltage supplied between the conductive layers 11 and 14 to the ferroelectric layer 12. Namely, the control layer 13 has such a property that the voltage supplied between the conductive layers 11 and 14 is applied to only one portion (i.e. an extremely small area) of the ferroelectric layer 12 corresponding to the irradiation position of the energy beam B. In order to realize the function of selecting whether or not to apply the voltage to the ferroelectric layer 12, the control layer 13 desirably has such a property that it is substantially an insulator in the normal state, but reversibly becomes a conductor by the irradiation of the energy beam B. However, the extent (magnitude) of the insulation property of the control layer 13 in the normal state may be large enough to prevent the influence of the voltage supplied between the conductive layers 11 and 14 from extending a place other than the one portion of the ferroelectric layer 12 corresponding to the irradiation position of the energy beam B. Moreover, the extent (magnitude) of the conductivity of the control layer 13 at the irradiation position in the irradiation of the energy beam B may be large enough to attain a predetermined purpose of the voltage application (e.g. the reverse of the polarization in the voltage application in recording) by applying the voltage supplied between the conductive layers 11 and 14 to the one portion of the ferroelectric layer 12 corresponding to the irradiation position of the energy beam B.

The control layer 13 is formed on the ferroelectric layer 12. The control layer 13 is formed in a plate shape or in a thin-film shape. The control layer 13 is formed from a material in which its conductivity is reversibly increased by the irradiation of the energy beam B. Specifically, the control layer 13 in the first embodiment is formed from a material which has a property that the conductivity of the control layer 13 is increased in accordance with increase of a temperature of the control layer 13 caused by the irradiation of the energy beam. For example, the control layer 13 is formed from a semiconductor. More specifically, the control layer 13 is formed from polysilicon, amorphous, or germanium.

The thickness of the control layer 13 is determined by considering: an increasing rate of electric-field strength between the conductive layers 11 and 14 in the irradiation of the energy beam B; and a gradient G (refer to FIG. 2) in an area in which the conductivity is increased by the irradiation of the energy beam B (this area is referred to as a “conductive area A”.). The increasing rate of electric-field strength between the conductive layers 11 and 14 in the irradiation of the energy beam B is calculated by the following equation.
(Tf+Tc)/Tf
where Tf is the ferroelectric layer thickness, Tc is the control layer thickness. Therefore, in order to increase the increasing rate of electric-field strength, it is desirable to thicken the control layer 13. On the other hand, as the control layer 13 is thicker, the gradient G is gentler in the conductive area A. If the gradient G becomes gentle, the conductive area A increases in size, to thereby increase a diameter D1 of the area of the ferroelectric layer 12 to which the voltage supplied between the conductive layers 11 and 14 is applied. As a result, in the ferroelectric layer 12, an area used for the recording of one unit (e.g. 1 bit) of the information increases in size, and thereby, the recording density of the information decreases. Thus, the thickness of the control layer 13 is desirably set while looking for a harmonious point between a request for securing the reasonable increasing rate of electric-field strength and a request for securing the reasonable gradient G. Specifically, the thickness of the control layer 13 is desirably about twice to ten times as thick as that of the ferroelectric layer 12.

The conductive layer 14 functions as an electrode for applying a voltage to the ferroelectric layer 12, along with the conductive layer 11. The conductive layer 14 is formed on the control layer 13. The conductive layer 14 is formed from a conductive material. For example, the conductive layer 14 is formed from metal, such as aluminum, platinum, gold, copper, and nickel. The conductive layer 14 is formed in a thin-film shape. The thickness of the conductive layer 14 is determined by considering security of high conductivity of the conductive layer 14 and restriction of thermal diffusion caused by the irradiation of the energy beam B. In order to secure the high conductivity of the conductive layer 14, even if the conductive layer 14 is formed in a super thin film shape, it is desirable to remain a certain degree of thickness. On the other hand, in order to restrict the thermal diffusion in the conductive layer 14 in the irradiation of the energy beam B, it is desirable to make the conductive layer 14 thin. Thus, the thickness of the conductive layer 14 is desirably set while looking for a harmonious point between a request for securing the high conductivity and a request for securing the restriction of the thermal diffusion. Specifically, the thickness of the control layer 14 is desirably about 1 to 100 nanometers.

Incidentally, the energy beam B may be any beam if capable of increasing the temperature of the control layer 13 at the irradiation position. For example, the energy beam B is desirably a light beam or an electron beam.

The principle in which the information is recorded into the recording medium 10 is as follows. At first, a voltage is supplied between the conductive layers 11 and 14. The voltage level is set to be large enough to form an electric field beyond the coercive electric field of the ferroelectric layer 12. Incidentally, if only supplied between the conductive layers 11 and 14, the voltage is cut off by the insulation property of the control layer 13 in the normal state, and the voltage is not applied to the ferroelectric layer 12.

Then, the irradiation position of the energy beam B is focused on a position at which the information is to be recorded (i.e. a recording position), and the surface of the conductive layer 11 is irradiated with the energy beam B. By this, the energy of the energy beam B is transferred to the control layer 13 through the conductive layer 11, so that the temperature of the control layer 13 locally increases and the conductivity of the control layer 13 locally increases. As a result, the conductive area A having a cross sectional shape as shown in FIG. 2 is formed in the control layer 13.

If the conductive area A is formed in the control layer 13, the voltage supplied between the conductive layers 11 and 14 is applied to the recording position of the ferroelectric layer 12 through the conductive area A. By this, the polarization direction at the recording position of the ferroelectric layer 12 is locally reversed. This means that one unit of the information is recorded in the ferroelectric layer 12.

Then, if the recording of the information is continued, the irradiation position of the energy beam B is displaced. By this, in the portion of the control layer which has been irradiated with the energy beam B, the temperature decreases because of no more irradiation of the energy beam B, so that the conductivity decreases. As a result, the conductive area A disappears. By this, the insulation property of the control layer 13 in the normal state is recovered, so that the voltage supplied between the conductive layers 11 and 14 is cut off by the control layer 13, and the voltage is no longer applied to the recording position of the ferroelectric layer 12. At a new irradiation position of the energy beam B, a new conductive area is formed in the control layer 13. The voltage supplied between the conductive layers 11 and 14 is applied to a new recording position of the ferroelectric layer 12 through the new conductive area. By this, the polarization direction at the new recording position of the ferroelectric layer 12 is reversed.

If the recording of the information is completed, the irradiation of the energy beam B is stopped. By this, the conductive area in the control layer 13 disappears, and the voltage supplied between the conductive layers 11 and 14 is no longer applied to the ferroelectric layer 12. Incidentally, even if the voltage is not applied to the ferroelectric layer 12, the information recorded in the ferroelectric layer 12 is held as it is, because of the property of spontaneous polarization of a ferroelectric substance.

Next, the principle in which the information recorded and held in the recording medium is reproduced in the SNDM method is as follows. At first, an alternating voltage is supplied between the conductive layers 11 and 14. The amplitude level of the alternating voltage is set to be large enough to form an electric field smaller than the coercive electric field of the ferroelectric layer 12.

Then, the irradiation position of the energy beam B is focused on a position at which the information is to be read (i.e. a reading position), and the surface of the conductive layer 11 is irradiated with the energy beam B. By this, the energy of the energy beam B is transferred to the control layer 13 through the conductive layer 11, so that the temperature of the control layer 13 locally increases and the conductivity of the control layer 13 locally increases. As a result, the conductive area A having a cross sectional shape as shown in FIG. 2 is formed in the control layer 13.

If the conductive area A is formed in the control layer 13, the alternating voltage supplied between the conductive layers 11 and 14 is applied to the reading position of the ferroelectric layer 12 through the conductive area A. By this, an alternating electric field is generated in the ferroelectric layer 12. Along with an alternating change of the electric field, the capacitance of the ferroelectric layer 12 changes. At this time, the capacitance change of the ferroelectric layer 12 causes different curves depending on whether the polarization direction at the reading position is upward or downward. This is because the non-linear dielectric constant at the reading position varies depending on whether the polarization direction at the reading position is upward or downward. By electrically detecting the difference in the curve of the capacitance change, it is possible to know the polarization direction at the reading position of the ferroelectric layer 12. Thus, it is possible to reproduce the information recorded at the reading position. The electrical detection of the curve of the capacitance change is performed through the conductive area A.

Then, if the reading of the information is continued, the irradiation position of the energy beam B is displaced. By this, in the portion of the control layer which has been irradiated with the energy beam B, the temperature decreases because of no more irradiation of the energy beam B, so that the conductivity decreases. As a result, the conductive area A disappears. By this, the insulation property of the control layer 13 in the normal state is recovered, so that the alternating voltage supplied between the conductive layers 11 and 14 is cut off by the control layer 13, and the voltage is no longer applied to the reading position of the ferroelectric layer 12. At a new irradiation position of the energy beam B, a new conductive area is formed in the control layer 13. The alternating voltage supplied between the conductive layers 11 and 14 is applied to a new reading position of the ferroelectric layer 12 through the new conductive area. By this, the capacitance change at the new reading position of the ferroelectric layer 12 is detected.

If the reading of the information is completed, the irradiation of the energy beam B is stopped. By this, the conductive area in the control layer 13 disappears, and the alternating voltage supplied between the conductive layers 11 and 14 is no longer applied to the ferroelectric layer 12.

As described above, the recording medium 10 is provided with the control layer 13 on a route of the voltage application with respect to the ferroelectric layer 12, and changes the conductivity of the control layer 13 by presence or absence, or strength or weakness, of the irradiation of the energy beam B. By this construction, it is possible to locally increase the conductivity of the control layer 13 by the irradiation of the energy beam B to thereby form the conductive area A, and it is possible to apply a voltage to the recording position or reading position of the ferroelectric layer 12 through the conductive area A. Since the conductive area A has a function of locally applying a voltage to the ferroelectric layer (i.e. a recording layer) of the recording medium, the conductive area A performs the same function as a probe in the ferroelectric recording in the conventional SNDM method. In this regard, the conductive area A may be referred to as a “virtual probe”.

By virtue of the construction and operation of the recording medium 10, the following effects can be achieved. First, according to the recording medium 10, it is possible to select the recording position or the reading position by the irradiation of the energy beam B, so that a probe formed from a solid, such as metal, is unnecessary. Namely, it is possible to realize a ferroelectric recording medium of a completely non-contact type, by the first embodiment of the present invention. Therefore, it is possible to dissolve the disadvantage, such as abrasion and damage of the probe, and abrasion and damage of the recording medium, caused by the contact between the probe and the surface of the recording medium. Moreover, since there is no abrasion caused by the contact between the probe and the surface of the recording medium, it is possible to speed up the scan for recording or reproducing the information with respect to the recording medium. Incidentally, the “completely non-contact” means not only that it is unnecessary to contact the solid probe or head with the recording medium in recording and reading the information, but also that it is unnecessary to bring the solid probe or head extremely close to the recording medium (e.g. at a small distance of approximately several or several tens nanometers).

Then, according to the recording medium 10, it is possible to heat the recording medium 10 as a whole from the exterior, increase the temperature of the entire control layer 13, and increase the conductivity of the entire control layer 13. Then, with the conductivity of the entire control layer 13 increased, if a voltage, which is large enough to form an electric field beyond the coercive electric field of the ferroelectric layer 12, is applied between the conductive layers 11 and 14, it is possible to arrange the polarization directions of all positions of the ferroelectric layer 12 in one direction. By this, it is possible to delete all the information held in the ferroelectric layer 12 and initialize the recording medium 10. By increasing the conductivity of the entire control layer 13, a voltage can be applied to the entire ferroelectric layer 12 at a time, so that it is possible to initialize the recording medium 10 quickly.

Incidentally, there are other ways to initialize the recording medium 10. For example, a voltage is supplied between the conductive layers 11 and 14. The voltage is much larger than a voltage to be applied in recording, and has an intensity large enough to form an electric field beyond the coercive electric field of the ferroelectric layer 12, despite an extremely large resistance value (large enough to say that there is the insulation property in recording) owned by the control layer 13 in the normal state. In such a method, it is possible to initialize the recording medium 10 at a time, to thereby reduce an initializing time length. Moreover, in order to initialize the recording medium 10, it is possible to supply a relatively large voltage between the conductive layers 11 and 14, and heat the recording medium 10 as a whole. By this, it is possible to reduce both the intensity of the voltage supplied between the conductive layers 11 and 14, and the heat applied to the recording medium 10, as compared to the case where only the voltage or the heat is applied.

Then, according to the recording medium 10, the conductive area A is formed in the control layer 13 by the irradiation of the energy beam B. As shown in FIG. 2, the conductive area A has the gradient G, and the gradient G can be set arbitrarily, by using the thickness of the control layer 13 or the intensity of the energy beam B, or the like. By appropriately setting the gradient G, it is possible to make a diameter D1 of an area where a voltage is applied to the ferroelectric layer 12 through the conductive area A (which is a diameter of a recording spot on the surface of the ferroelectric layer 12, in other words, a diameter of a tip of the virtual probe) smaller than a diameter D2 of the energy beam. Therefore, it is possible to improve the recording density.

In the conventional optical memory described in Japanese Patent Publication NO. 2869651, there is such a problem that it is not easy to select the ferroelectric material to be used, because of the necessity to consider the Curie point of the ferroelectric thin film. However, in the recording medium 10 in the first embodiment of the present invention, the ferroelectric layer 12 itself is not heated. Therefore, according to the recording medium 10, in selecting the ferroelectric material, it is unnecessary to consider the Curie point of the ferroelectric thin film. In this regard, it is easy to select the ferroelectric material.

### Second Embodiment of Recording Medium

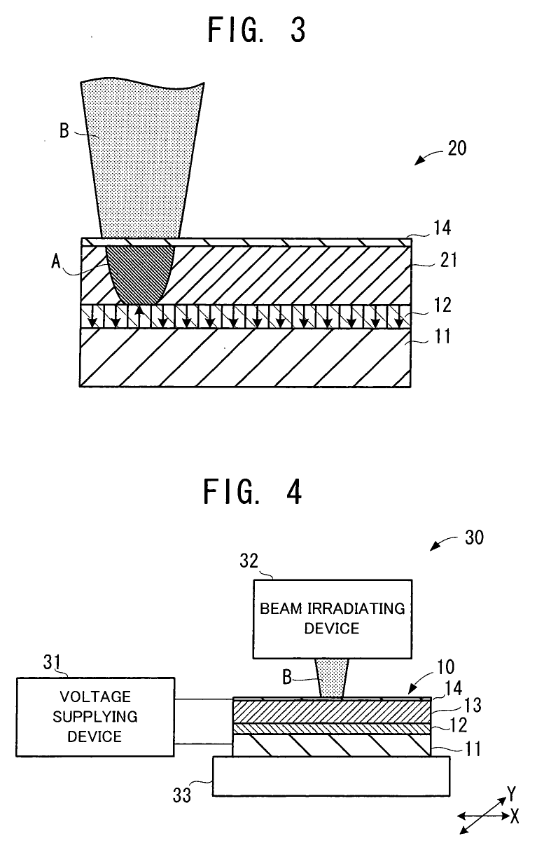

The second embodiment of the recording medium of the present invention will be explained. FIG. 3 shows the recording medium in the second embodiment of the present invention and an energy beam emitted to the recording medium. As shown in FIG. 3, a recording medium 20 is provided with: the conductive layer 11; the ferroelectric layer 12; and the conductive layer 14, as in the recording medium 10 shown in FIG. 1.

As with the control layer 13 of the recording medium 10, a control layer 21 of the recording medium 20 has such a property that its conductivity is reversibly increased by irradiation of the energy beam B. The control layer 21 has such a property that it changes the conductivity by presence or absence, or strength or weakness, of the energy beam B. By using this property, the control layer 21 selects whether or not to apply a voltage supplied between the conductive layers 11 and 14 to the ferroelectric layer 12. However, as opposed to the control layer 13, the control layer 21 is formed from a material which has a property that the conductivity of the control layer 21 is increased in accordance with generation of a carrier in a thermal non-equilibrium state in the control layer 21 caused by the irradiation of the energy beam. Specifically, the control layer 21 is formed from a material having a property of causing an electron multiplication phenomenon (or electron avalanche phenomenon), such as serene, germanium, gallium arsenide (GaAs), and gallium phosphorus (GaP) for example.

Even the recording medium 20 having such a construction can achieve substantially the same effect as that of the recording medium 10.

### Another Embodiment of Recording Medium

In the recording medium of the present invention, by virtue of the irradiation of the energy beam, the conductivity of the control layer is locally increased, and the conductive area (the virtual probe) is formed at the portion. In the recording medium 10 shown in FIG. 1, the irradiation of the energy beam B causes the temperature of the control layer 13 to be locally increased, to thereby form the conductive area A. Moreover, in the recording medium 20 shown in FIG. 3, the irradiation of the energy beam B causes the carrier in the thermal non-equilibrium state in the control layer 21, to thereby form the conductive area A. However, the present invention is not limited these embodiments. For example, the conductive area may be formed by forming an electron density gradient in the control layer by the irradiation of the energy beam. Specifically, the conductive layer, which is located on the side irradiated with the energy beam, is formed to be thin enough for an electron to barely move, and the control layer is formed from a semiconductor (e.g. silicon, germanium, or the like) having slightly lower conductivity than that of the conductive layer. By this, in the control layer, it is possible to form the electron density gradient by centering on the spot that is irradiated with the energy beam. Then, the electron density gradient can be displaced by the displacement of the energy beam.

On the other hand, in the recording medium 10 shown in FIG. 1 and FIG. 2, the gradient G of the conductive area A is appropriately set by using the thickness of the control layer 13 or the intensity of the energy beam B, or the like. By this, it is tried to reduce the diameter D1 of an area where a voltage is applied to the ferroelectric layer 12 through the conductive area A (i.e. the diameter of the tip of the virtual probe), to thereby improve the recording density. However, the method to reduce the diameter D1 is not limited to this method. For example, the control layer may be formed from a material having thermal conductivity anisotropy or electric conductivity anisotropy (e.g. silicon or the like). The cross sectional shape of the conductive area formed in the control layer by the irradiation of the energy beam may be an elongate shape in a direction perpendicular to the surface of the recording medium.

### Embodiment of Recording Apparatus

The embodiment of the recording apparatus of the present invention will be explained. FIG. 4 shows the recording apparatus in the embodiment of the present invention, as well as the recording medium. A recording apparatus 30 in FIG. 4 is an apparatus for recording the information into the recording medium of the present invention, such as the recording medium 10 and the recording medium 20. As with a hard disk drive, an optical disk drive, and the like, the recording apparatus 30 can be used for various equipment, such as a computer, an audio-video recorder, control equipment, and medical equipment. Incidentally, for convenience of explanation, it is illustrated that the information is recorded by the recording apparatus 30 into the recording medium 10.

As shown in FIG. 4, the recording apparatus 30 is provided with: a voltage supplying device 31; a beam irradiating device 32; and an irradiation position controlling device 33.

The voltage supplying device 31 supplies a voltage for setting the polarization direction of the ferroelectric layer 12. The voltage supplying device 31 supplies the voltage between the conductive layers 11 and 14 of the recording medium 10. The voltage supplying device 31 can supply a voltage having an intensity large enough to form an electric field beyond the coercive electric field of the ferroelectric layer 12. The voltage supplying device 31 can be realized by a Direct Current (DC) voltage generation circuit or a pulse voltage generation circuit, an amplification circuit, or the like.

The beam irradiating device 32 irradiates the recording medium 10 with the energy beam B, such as a light beam and an electron beam. If the energy beam B is the light beam, the beam irradiating device 32 can be realized by an optical system, such as a semiconductor laser and a lens. If the energy beam B is the electron beam, the beam irradiating device 32 can be realized by an electron beam apparatus provided with an electron gun, for example.

The irradiation position controlling device 33 displaces the irradiation position of the energy beam B with respect to the recording medium 10, in a direction parallel to the surface of the recording medium 10. In order to displace the irradiation position of the energy beam B with respect to the recording medium 10, there are two methods: one is a method of displacing the recording medium 10 while fixing an irradiation route on which the energy beam B reaches from the beam irradiating device 32 to the recording medium 10; and the other is a method of displacing the irradiation route of the energy beam B while fixing the recording medium 10. The irradiation position controlling device 33 can be realized by any method. The irradiation position controlling device 33 shown in FIG. 4 adopts the method of displacing the recording medium 10 while fixing the irradiation route of the energy beam B. For example, the irradiation position controlling device 33 may be an X-Y stage, and can displace the recording medium 10 mounted on the stage, in an X direction and a Y direction, parallel to the surface of the recording medium 10.

The operation of the recording apparatus 30 is as follows. When the information is recorded into the recording medium 10, at first, the irradiation position controlling device 33 displaces the recording medium 10 in the X direction and the Y direction, and matches the irradiation position of the energy beam B with a position in the recording medium 10 (i.e. the recording position) where the information is to be recorded. Then, the voltage supplying device 31 supplies a voltage for setting the polarization direction of the ferroelectric layer 12 between the conductive layers 11 and 14 of the recording medium 10. Moreover, the beam irradiating device 32 irradiates the recording medium 10 with the energy beam B. By this, in the recording medium 10, the conductive area A (i.e. the virtual probe) is formed at the irradiation position of the energy beam B, and the voltage supplied between the conductive layers 11 and 14 is applied to the recording position of the ferroelectric layer 12 through the conductive area A. Then, the polarization direction at the recording position is reversed, and thus the information is recorded.

As described above, according to the recording apparatus 30, by virtue of the irradiation of the energy beam B, the conductive area A (i.e. the virtual probe) can be formed in the control layer 13 of the recording medium 10. By this, it is possible to select the recording position of the information in the ferroelectric layer 12. Therefore, according to the recording apparatus 30, it is possible to realize the ferroelectric recording of a completely non-contact type. Thus, a solid probe is unnecessary, which no longer causes the problems such as abrasion and damage of the probe, and abrasion and damage of the recording medium, caused by the contact or friction between the probe and the recording medium. Therefore, according to the recording apparatus 30, it is possible to realize the recording apparatus which is excellent in durability and which is long-lived. Moreover, since there is no contact between the solid probe and the recording medium, it is possible to speed up the scan for recording the information with respect to the recording medium.

### Various Aspects of Embodiment of Recording Apparatus

The various aspects of the recording apparatus of the present invention will be explained. On the recording apparatus 30, the information is recorded, by the voltage supplying device 31 supplying a voltage, at the same time of (or together with) the beam irradiating device 32 emitting the energy beam, with respect to the recording medium 10. There are two methods in such recording methods. Namely, a first method is a method of emitting the energy beam B modulated by the information to be recorded, from the beam irradiating device 32, in such a condition that a voltage is continuously supplied by the voltage supplying device 31 between the conductive layers 11 and 14. A second method is a method of supplying a voltage modulated by the information to be recorded, by the voltage supplying device 31 between the conductive layers 11 and 14, in such a condition that the recording medium 10 is continuously irradiated with the energy beam B by the beam irradiating device 32.

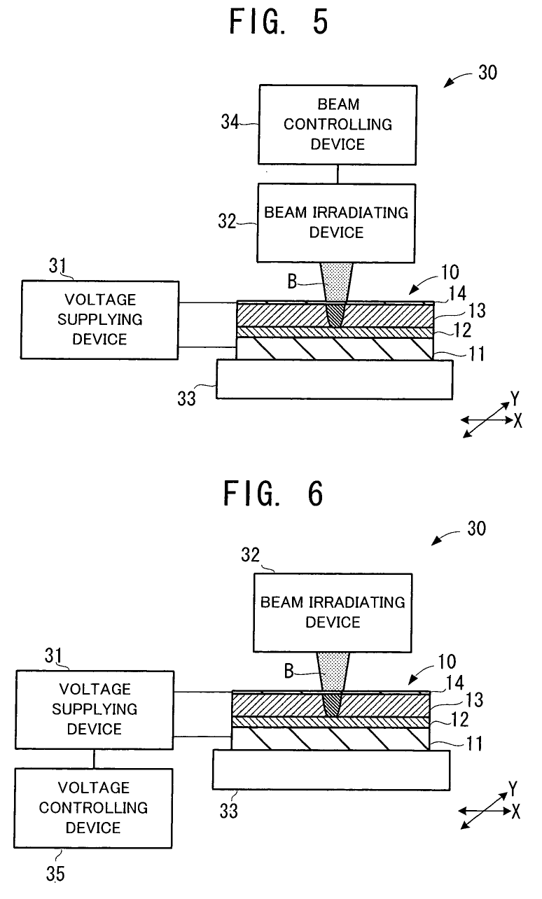

FIG. 5 shows one aspect of the recording apparatus 30 in which the first method is adopted. In this aspect, the recording apparatus 30 is provided with a beam controlling device 34 for controlling presence or absence, or strength or weakness, of the energy beam B, in association with the information to be recorded into the recording medium 10.

For example, it is assumed that in the recording medium 10 (i.e. the ferroelectric layer 12), binary digital data is continuously recorded at a plurality of recording positions aligned in a direction parallel to the surface of the recording medium 10 (e.g. a plurality of recording positions aligned on linear tracks). In this case, on the recording apparatus 30, at first, the irradiation position controlling device 33 displaces the recording medium 10 in the X direction and the Y direction, and matches the irradiation position of the energy beam B with a record start position in the recording medium 10. Then, the voltage supplying device 31 supplies a voltage between the conductive layers 11 and 14 of the recording medium 10. Then, the beam irradiating device 32 starts the irradiation of the energy beam B. Then, the irradiation position controlling device 33 displaces the recording medium 10 linearly at a predetermined speed in the X direction, for example. At the same time, the beam controlling device 34 modulates the energy beam B on the basis of the digital data to be recorded. For example, if the bit state of the digital data to be recorded is “0”, the beam controlling device 34 temporarily stops the energy beam B or temporarily weakens the intensity of the energy beam B. If the bit state of the digital data to be recorded is “1”, the beam controlling device 34 maintains or temporarily intensifies the intensity of the energy beam B. By this, the binary digital data is continuously recorded into the recording medium 10 (i.e. the ferroelectric layer 12). Incidentally, the beam controlling device 34 can be realized by a signal processing circuit or the like.

FIG. 6 shows one aspect of the recording apparatus 30 in which the second method is adopted. In this aspect, the recording apparatus 30 is provided with a voltage controlling device 35 for controlling presence or absence, or strength or weakness, of voltage supply, in association with the information to be recorded into the recording medium 10.

For example, it is assumed that in the recording medium 10 (the ferroelectric layer 12), binary digital data is continuously recorded at a plurality of recording positions continuously arranged in a direction parallel to the surface of the recording medium 10. In this case, on the recording apparatus 30, at first, the irradiation position controlling device 33 displaces the recording medium 10 in the X direction and the Y direction, and matches the irradiation position of the energy beam B with the record start position in the recording medium 10. Then, the beam irradiating device 32 starts the irradiation of the energy beam B. Then, the voltage supplying device 31 supplies a voltage (i.e. a recording voltage) between the conductive layers 11 and 14 of the recording medium 10. Then, the irradiation position controlling device 33 displaces the recording medium 10 linearly at a predetermined speed in the X direction, for example. At the same time, the voltage controlling device 35 modulates the recording voltage on the basis of the digital data to be recorded. For example, if the bit state of the digital data to be recorded is “0”, the voltage controlling device 35 temporarily sets the recording voltage to zero or temporarily weakens the recording voltage. If the bit state of the digital data to be recorded is “1”, the voltage controlling device 35 maintains or temporarily intensifies the intensity of the recording voltage. By this, the binary digital data is continuously recorded into the recording medium 10 (the ferroelectric layer 12). Incidentally, the voltage controlling device 35 can be realized by a signal processing circuit or the like.

### Embodiment of Reproducing Apparatus

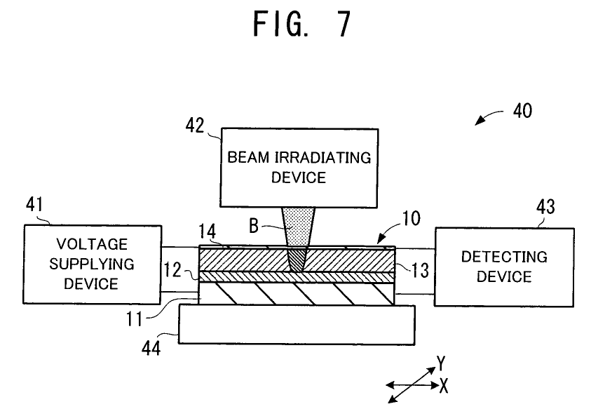

The embodiment of the reproducing apparatus of the present invention will be explained. FIG. 7 shows the reproducing apparatus in the embodiment of the present invention, as well as the recording medium. A reproducing apparatus 40 in FIG. 7 is an apparatus for reproducing the information held in the recording medium of the present invention, such as the recording medium 10 and the recording medium 20. As with a hard disk drive, an optical disk drive, and the like, the reproducing apparatus 40 can be used for various equipment, such as a computer, an audio-video recorder, control equipment, and medical equipment. Incidentally, for convenience of explanation, it is illustrated that the information held in the recording medium 10 is reproduced by the reproducing apparatus 40 in the SNDM method.

As shown in FIG. 7, the reproducing apparatus 40 is provided with: a voltage supplying device 41; a beam irradiating device 42; a detecting device 43; and an irradiation position controlling device 44.

The voltage supplying device 41 supplies a voltage between the conductive layers 11 and 14 of the recording medium 10. In the recording medium 10, the information is held as the polarization direction of the ferroelectric layer 12. The polarization direction of the ferroelectric layer 12 can be known by detecting the non-linear dielectric constant of the ferroelectric layer 12. Moreover, the non-linear dielectric constant of the ferroelectric layer 12 can be known by detecting the capacitance of the ferroelectric layer 12 in such a condition that an electric field smaller than the coercive electric field of the ferroelectric layer 12 (hereinafter referred to as an “electric field for detection”) is applied to the ferroelectric layer 12. The voltage supplied by the voltage supplying device 41 between the conductive layers 11 and 14 of the recording medium 10 is to form the electric field for detection. The electric field for detection is desirably an alternating electric field. Therefore, the voltage to be supplied from the voltage supplying device 41 is desirably an alternating voltage. The voltage supplying device 41 can be realized by an Alternating Current (AC) power source, an amplification circuit, or the like.

Incidentally, in the SNDM method, there are a method in which an alternating electric field is used as the electric field for detection, and a method in which a DC electric field is used as the electric field for detection. In the above-described each embodiment and an example described later, it is illustrated that the method in which the alternating electric field is used as the electric field for detection is adopted. The present invention, however, can be applied to the case where the DC electric field is used as the electric field for detection. In this case, the voltage to be supplied from the voltage supplying device 41 is a DC voltage. Then, in this case, the voltage supplying device 41 can be realized by a DC power source, an amplifier circuit, or the like.

The beam irradiating device 42 irradiates the recording medium 10 with the energy beam B, such as a light beam and an electron beam. If the energy beam B is the light beam, the beam irradiating device 42 can be realized by an optical system, such as a semiconductor laser and a lens. If the energy beam B is the electron beam, the beam irradiating device 42 can be realized by an electron beam apparatus provided with an electron gun, for example.

The detecting device 43 detects the polarization direction of the ferroelectric layer 12 of the recording medium 10. The polarization direction of the ferroelectric layer 12 can be detected by detecting the non-linear dielectric constant of the ferroelectric layer 12. Thus, it is desirable to provide the detecting device 43 with a non-linear dielectric constant detecting device for detecting a non-linear dielectric constant of the ferroelectric layer 12. Explaining more specifically, the non-linear dielectric constant of the ferroelectric layer 12 can be known by applying an alternating electric field smaller than the coercive electric field of the ferroelectric layer 12 to the ferroelectric layer 12 and detecting, in that condition, the capacitance change of the ferroelectric layer 12. Thus, it is desirable to provide the detecting device 43 with a device for detecting the capacitance change of the ferroelectric layer 12, as the non-linear dielectric constant detecting device. The above-described Japanese Patent Application Laying Open NO. 2003-085969 describes a device for applying an alternating electric field to the ferroelectric layer to form a frequency modulation signal corresponding to the capacitance change of the ferroelectric layer and detecting the capacitance change of the ferroelectric layer on the basis of the frequency modulation signal. The detecting device 43 can be realized by substantially the same device as this (although not the solid probe but the virtual probe, which is formed in the control layer 13 caused by the irradiation of the energy beam B, is used in the reproducing apparatus 40 as being the embodiment of the present invention).

The irradiation position controlling device 44 displaces the irradiation position of the energy beam B with respect to the recording medium 10, in a direction parallel to the surface of the recording medium 10. In order to displace the irradiation position of the energy beam B with respect to the recording medium 10, there are two methods: one is a method of displacing the recording medium 10 while fixing an irradiation route on which the energy beam B reaches from the beam irradiating device 42 to the recording medium 10; and the other is a method of displacing the irradiation route of the energy beam B while fixing the recording medium 10. The irradiation position controlling device 44 can be realized by any method. The irradiation position controlling device 44 shown in FIG. 7 adopts the method of displacing the recording medium 10 while fixing the irradiation route of the energy beam B. For example, the irradiation position controlling device 44 may be an X-Y stage, and can displace the recording medium 10 mounted on the stage, in the X direction and the Y direction in FIG. 7.

The operation of the reproducing apparatus 40 is as follows. When the information held in the recording medium 10 is reproduced, at first, the irradiation position controlling device 44 displaces the recording medium 10 in the X direction and the Y direction, and matches the irradiation position of the energy beam B with a position in the recording medium 10 (i.e. the reading position) where the information to be reproduced is held. Then, the voltage supplying device 41 supplies an alternating voltage between the conductive layers 11 and 14 of the recording medium 10. Then, the beam irradiating device 42 irradiates the recording medium 10 with the energy beam B. By this, in the recording medium 10, the conductive area A (i.e. the virtual probe) is formed at the irradiation position of the energy beam B, and the alternating voltage supplied between the conductive layers 11 and 14 is applied to the reading position of the ferroelectric layer 12 through the conductive area A. Then, through the conductive area A, the reading position of the ferroelectric layer 12 and the detecting device 43 are electrically connected. Then, the detecting device 43 detects the capacitance change at the reading position of the ferroelectric layer 12. On the basis of the capacitance change, the information held at the reading position is reproduced.

As described above, according to the reproducing apparatus 40, by virtue of the irradiation of the energy beam B, the conductive area A (i.e. the virtual probe) can be formed in the control layer 13 of the recording medium 10. By this, it is possible to select the reading position of the information in the ferroelectric layer 12. Therefore, according to the reproducing apparatus 40, it is possible to realize the information reproduction of a completely non-contact type, in the ferroelectric recording medium. Thus, the solid probe is unnecessary, which no longer causes the problems such as abrasion and damage of the probe, and abrasion and damage of the recording medium, caused by the contact or friction between the probe and the recording medium. Therefore, according to the reproducing apparatus 40, it is possible to realize the reproducing apparatus which is excellent in durability and which is long-lived. Moreover, since there is no contact between the solid probe and the recording medium, it is possible to speed up the scan for reading the information with respect to the recording medium.

Incidentally, the recording apparatus and the reproducing apparatus in the embodiments as described above may be realized in a united form with hardware, as an exclusive apparatus, or may be realized by combining the hardware and software (i.e. a computer program).

### EXAMPLE

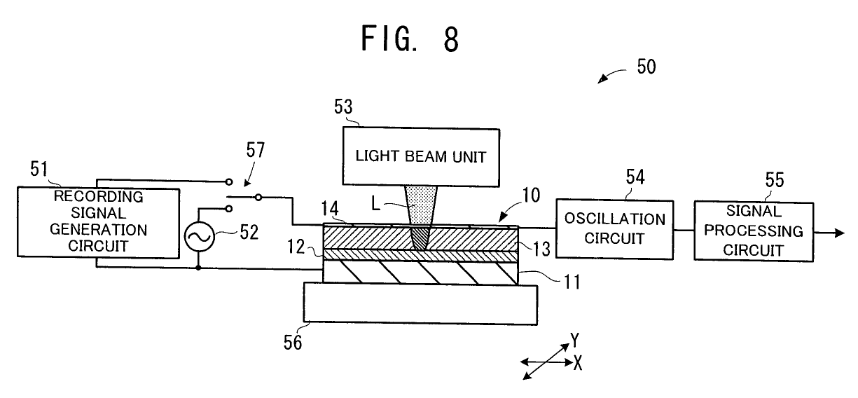

The example of the recording apparatus and the reproducing apparatus of the present invention will be explained below, with reference to the drawings. FIG. 8 shows a recording/reproducing apparatus in the example of the present invention. A recording/reproducing apparatus 50 in FIG. 8 has a function of recording information into the above-described recording medium 10 (refer to FIG. 1) and a function of reproducing the information held in the recording medium 10.

The recording/reproducing apparatus 50 is provided with: a recording signal generation circuit 51; an alternating voltage source 52; a light beam unit 53; an oscillation circuit 54; a signal processing circuit 55; an X-Y stage 56; and a switch 57.

The recording function of the recording/reproducing apparatus 50 is realized by the recording signal generation circuit 51; the light beam unit 53; and the X-Y stage 56. The recording signal generation circuit 51 is a circuit for generating a recording pulse signal corresponding to the information to be recorded in the recording medium 10 and supplying the recording pulse signal between the conductive layers 11 and 14 of the recording medium 10. The amplitude of the recording pulse signal is large enough to form an electric field in the ferroelectric layer 12, which is beyond the coercive electric field of the ferroelectric layer 12, when the recording pulse signal is applied to the ferroelectric layer 12 of the recording medium 10. The recording signal generation circuit 51 is constructed from a pulse signal generation circuit, an amplifier circuit, and the like. The light beam unit 53 is an apparatus for emitting a light beam L to the recording medium 10. The light beam unit 53 is constructed from a semiconductor laser, a lens, a mirror, and the like. The X-Y stage 56 is a mechanism for displacing the recording medium 10 in the X direction and the Y direction, which are parallel to the surface of the recording medium 10, with the recording medium 10 mounted thereon. The recording signal generation circuit 51, the light beam unit 53, and the X-Y stage are individually and electrically connected to a controller (not illustrated) for controlling the operation of the recording/reproducing apparatus 50. An output timing of the pulse signal, an irradiation timing of the light beam L, and the displacement of the recording medium 10, and the like are controlled by the controller.

When recording the information into the recording medium 10, the recording/reproducing apparatus 50 operates in the following manner. At first, on the basis of the control of the controller, the switch 57 electrically connects the recording signal generation circuit 51 with the conductive layer 14 of the recording medium 10. Then, the X-Y stage 56 displaces the recording medium 10 in the X direction and the Y direction, and matches the irradiation position of the light beam L with a position in the recording medium 10 (i.e. recording position) where the information is to be recorded. Then, the recording signal generation circuit 51 supplies the recording pulse signal between the conductive layers 11 and 14 of the recording medium 10. At the same time, the light beam unit 53 irradiates the recording medium 10 with the light beam L. By this, in the recording medium 10, the conductive area (i.e. the virtual probe) is formed at the irradiation position of the light beam L, and the voltage supplied between the conductive layers 11 and 14 is applied to the recording position of the ferroelectric layer 12 through the conductive area. Then, the polarization direction at the recording position is reversed, and thus the information is recorded.

The recording/reproducing apparatus 50 adopts the SNDM method. The reproduction function of the recoding/reproducing apparatus 50 is realized by the alternating voltage source 52, the light beam unit 53, the oscillation circuit 54, the signal processing circuit 55, and the X-Y stage 56. The alternating voltage source 52 supplies an alternating voltage between the conductive layers 11 and 14 of the recording medium 10. The amplitude of the alternating voltage is large enough to form an alternating electric field in the ferroelectric layer 12, which is smaller than the coercive electric field of the ferroelectric layer 12, when the alternating voltage is applied to the ferroelectric layer 12 of the recording medium 10. Moreover, the frequency of the alternating voltage is approximately 5 kHz, for example. The oscillation circuit 54 is a circuit for outputting a high frequency signal whose frequency changes in association with the capacitance change of the ferroelectric layer 12. The average frequency of the high frequency signal is approximately 1 GHz, for example. Specifically, the oscillation circuit 54 has an inductor, and is constructed to form a LC resonance circuit by using the inductance of the inductor and the capacitance of the ferroelectric layer 12. The signal processing circuit 55 is a circuit for converting a frequency change of the high frequency signal, outputted from the oscillation circuit 54, to a voltage change, and detecting the non-linear dielectric constant (i.e. the polarization direction) of the ferroelectric layer 12 on the basis of the voltage change. The signal processing circuit 55 is constructed of a frequency-voltage conversion circuit, a detection circuit, and the like. More specifically, the signal processing circuit 55 is constructed of a FM demodulation circuit, a lock-in amplifier, and the like. The alternating voltage source 52, the oscillation circuit 54, and the signal processing circuit 55 are also individually connected to the controller for controlling the operation of the recording/reproducing apparatus 50, and operate in accordance with the control of the controller.

When reproducing the information held in the recording medium 10, the recording/reproducing apparatus 50 operates in the following manner. At first, on the basis of the control of the controller, the switch 57 electrically connects the alternating voltage source 52 with the conductive layer 14 of the recording medium 10. Then, the X-Y stage 56 displaces the recording medium 10 in the X direction and the Y direction, and matches the irradiation position of the light beam L with a position in the recording medium 10 (i.e. the reading position) where the information to be reproduced is held. Then, the recording alternating voltage source 52 supplies an alternating voltage between the conductive layers 11 and 14 of the recording medium 10. At the same time, the light beam unit 53 irradiates the recording medium 10 with the light beam L. By this, in the recording medium 10, the conductive area (i.e. the virtual probe) is formed at the irradiation position of the light beam L, and the alternating voltage supplied between the conductive layers 11 and 14 is applied to the reading position of the ferroelectric layer 12 through the conductive area. As a result, an alternating electric field is formed at the reading position of the ferroelectric layer 12, and in accordance with the alternating electric field, the capacitance of the ferroelectric layer 12 at the reading position changes alternately. Moreover, the reading position of the ferroelectric layer 12 and the oscillation circuit 54 are electrically connected through the conductive area. Then, the oscillation circuit 54 outputs a high frequency signal whose frequency changes in association with the capacitance change at the reading position of the ferroelectric layer 12. Then, the signal processing circuit 55 converts a frequency change of the high frequency signal, outputted from the oscillation circuit 54, to a voltage change, and performs detection about the voltage change, to thereby reproduce the information.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-015891 filed on Jan. 23, 2004 including the specification, claims, drawings and summary is incorporated herein by reference in its entirety.

1. A recording medium for holding information by spontaneous polarization of a ferroelectric substance, said recording medium comprising:
a first conductive layer;
a ferroelectric layer which is formed on said first conductive layer and which holds the information by spontaneous polarization;
a control layer which is formed on said ferroelectric layer and in which conductivity thereof is reversibly increased by irradiation of an energy beam; and
a second conductive layer formed on said control layer.

2. The recording medium according to claim 1, wherein said control layer changes the conductivity thereof by presence or absence, or strength or weakness, of the energy beam, and selects whether or not to apply a voltage supplied between said first conductive layer and said second conductive layer to said ferroelectric layer.

3. The recording medium according to claim 1, wherein said control layer is substantially an insulator in a normal state, but reversibly becomes a conductor by the irradiation of the energy beam.

4. The recording medium according to claim 1, wherein said control layer has a property that the conductivity of said control layer is increased in accordance with an increase of a temperature of said control layer caused by the irradiation of the energy beam.

5. The recording medium according to claim 1, wherein said control layer has a property that the conductivity of said control layer is increased in accordance with a generation of a carrier in a thermal non-equilibrium state in said control layer caused by the irradiation of the energy beam.

6. The recording medium according to claim 1, wherein the energy beam is a light beam.

7. The recording medium according to claim 1, wherein the energy beam is an electron beam.

8. A recording apparatus for recording information into a recording medium comprising: a first conductive layer; a ferroelectric layer which is formed on said first conductive layer and which holds the information by spontaneous polarization; a control layer which is formed on said ferroelectric layer and in which conductivity thereof is reversibly increased by irradiation of an energy beam; and a second conductive layer formed on said control layer,
said recording apparatus comprising:
a voltage supplying device for supplying a voltage for setting a polarization direction of said ferroelectric layer between said first conductive layer and said second conductive layer;
a beam irradiating device for irradiating the recording medium with the energy beam; and
an irradiation position controlling device for displacing an irradiation position of the energy beam with respect to the recording medium, in a direction parallel to a surface of the recording medium.

9. The recording apparatus according to claim 8, further comprising a beam controlling device for controlling presence or absence, or strength or weakness, of the irradiation of the energy beam, in association with the information to be recorded into the recording medium.

10. The recording apparatus according to claim 8, further comprising a voltage controlling device for controlling presence or absence, or strength or weakness, of the supply of the voltage, in association with the information to be recorded into the recording medium.

11. The recording apparatus according to claim 8, wherein the energy beam is a light beam.

12. The recording apparatus according to claim 8, wherein the energy beam is an electron beam.

13. A reproducing apparatus for reproducing information held in a recording medium comprising: a first conductive layer; a ferroelectric layer which is formed on said first conductive layer and which holds the information by spontaneous polarization; a control layer which is formed on said ferroelectric layer and in which conductivity thereof is reversibly increased by irradiation of an energy beam; and a second conductive layer formed on said control layer,
said reproducing apparatus comprising:
a voltage supplying device for supplying a voltage between said first conductive layer and said second conductive layer;
a beam irradiating device for irradiating the recording medium with the energy beam;
a detecting device for detecting a polarization direction of said ferroelectric layer; and
an irradiation position controlling device for displacing an irradiation position of the energy beam with respect to the recording medium, in a direction parallel to a surface of the recording medium.

14. The reproducing apparatus according to claim 13, further comprising a non-linear dielectric constant detecting device for detecting a non-linear dielectric constant of said ferroelectric layer, in order to detect the polarization direction of said ferroelectric layer.

15. The reproducing apparatus according to claim 13, wherein
said voltage supplying apparatus comprises an alternating voltage supplying device for supplying an alternating voltage between said first conductive layer and said second conductive layer, and
said detecting device comprises:
a capacitance detecting device for detecting a capacitance change of said ferroelectric layer caused by an alternating electric field, when the alternating electric field is formed in said ferroelectric layer due to the supply of the alternating voltage by said alternating voltage supplying device and the irradiation of the energy beam by said beam irradiating device; and
a signal processing device for reproducing the information held by the spontaneous polarization of said ferroelectric layer, on the basis of the capacitance change of said ferroelectric layer, which is detected by said capacitance detecting device.

16. The reproducing apparatus according to claim 13, wherein the energy beam is a light beam.

17. The reproducing apparatus according to claim 13, wherein the energy beam is an electron beam.
